(19) United States
(12) Patent Application Publication
(10) Pub. No.: US 2025/0175696 A1
(43) Pub. Date: May 29, 2025

(54) INFORMATION PROCESSING SYSTEM CAPABLE OF CONTROLLING IMAGE-CAPTURABLE MOVING BODY, INFORMATION PROCESSING APPARATUS, CONTROL METHOD, AND STORAGE MEDIUM

(71) Applicant: CANON KABUSHIKI KAISHA, Tokyo (JP)

(72) Inventors: SHOTA YAMAGUCHI, Tokyo (JP); NAOKI KAKINUMA, Kanagawa (JP)

(21) Appl. No.: 18/955,133

(22) Filed: Nov. 21, 2024

(30) Foreign Application Priority Data
Nov. 28, 2023 (JP) 2023-200676

(51) Int. Cl. H04N 23/60; H04N 23/68

(52) U.S. Cl. CPC H04N 23/64; H04N 23/68

(57) ABSTRACT

An information processing system including a moving object involving maneuvering, and an image-capturable moving apparatus having an image capturing device mounted thereon which captures an image of the moving object. A controller acquires maneuvering instruction information of the moving object. Image-capturing condition controller controls image capturing performed by the image capturing device. The image-capturing condition controller controls image-capturing conditions at a time of image-capturing performed by the image capturing device based on the maneuvering instruction information.

### BACKGROUND OF THE INVENTION

### Field of the Invention

The present invention relates to an information processing system that is capable of controlling an image-capturable moving body, an information processing apparatus, a control method, and a storage medium, and more particularly to an information processing system that controls acquisition of a video, as a material used for generating a moving image, from an image-capturable moving apparatus, an information processing apparatus, a control method, and a storage medium.

### Description of the Related Art

Conventionally, there is known a technique for dynamically controlling image-capturing conditions of an image capturing device installed in an image-capturable moving apparatus, such as a drone, according to information on surroundings. For example, there has been proposed a method of increasing a frame rate of an image capturing device installed in a drone in a case where the drone has detected an object from an image captured by the image capturing device and approaches the detected object (see e.g. Japanese Laid-Open Patent Publication (Kokai) No. 2021-158579). Further, there has been proposed a method of changing the exposure of an image capturing device installed in a drone based on information on surroundings, such as map information of surroundings (see e.g. Japanese Laid-Open Patent Publication (Kokai) No. 2022-053417).

However, in the conventional methods, the image-capturing conditions of the image capturing device installed in the drone are changed based on a result of analysis of a captured image and the information on surroundings. Therefore, there is a problem that in a case where a change in the movement of a moving body which is a shooting target is fast or large, the timing of changing the image-capturing conditions is delayed, or the changed image-capturing conditions are not those desired by a user, which makes it impossible to acquire a video desired by the user.

### SUMMARY OF THE INVENTION

The present invention provides an information processing system that is capable of quickly and accurately changing image-capturing conditions of an image capturing device installed in an image-capturable moving body according to a change in the movement of a moving object, which can be caused by a steering control of a user, an information processing apparatus, a control method, and a storage medium.

In a first aspect of the present invention, there is provided an information processing system including a moving object involving maneuvering, and an image-capturable moving apparatus having an image capturing device mounted thereon which captures an image of the moving object, including at least one processor, and a memory coupled to the at least one processor storing instructions that, when executed by the processor, cause the processor to function as: an acquisition unit configured to acquire maneuvering instruction information of the moving object, and an image capturing control unit configured to control image capturing performed by the image capturing device, wherein the image capturing control unit controls image-capturing conditions at a time of image-capturing performed by the image capturing device, based on the maneuvering instruction information.

In a second aspect of the present invention, there is provided an information processing apparatus that is communicably connected to a moving object involving maneuvering and an image-capturable moving apparatus having an image capturing device mounted thereon which captures an image of the moving object, including at least one processor, and a memory coupled to the at least one processor storing instructions that, when executed by the processor, cause the processor to function as: an acquisition unit configured to acquire maneuvering instruction information of the moving object from the moving object, and an image capturing control unit configured to control image capturing performed by the image capturing device, wherein the image capturing control unit transmits image-capturing conditions at a time of image-capturing to the image-capturable moving apparatus based on the maneuvering instruction information.

According to the present invention, it is possible to quickly and accurately changing image-capturing conditions of an image capturing device installed in an image-capturable moving body according to a change in the movement of a moving object, which can be caused by a steering control of a user.

Further features of the present invention will become apparent from the following description of exemplary embodiments (with reference to the attached drawings).

### BRIEF DESCRIPTION OF THE DRAWINGS

FIG. 1 is a block diagram showing an example of respective hardware configurations of an image-capturable moving apparatus and a moving object as a shooting target of the image-capturable moving apparatus, in an information processing system according to a first embodiment of the present invention.

FIG. 2 is a flowchart of a process performed by the image-capturable moving apparatus in a video recording process according to the first embodiment.

FIG. 3 is a flowchart of a process performed by the moving object in the video recording process according to the first embodiment.

FIG. 4 is a diagram showing a shooting scenario list in the first embodiment.

FIG. 5A is a diagram showing a relationship between changes in scene attention-getting degree in a shot video and an example of video editing.

FIG. 5B is a diagram showing a relationship between a scene attention-getting degree and maneuvering instruction information.

FIG. 6 is a flowchart of a change necessity determination process performed in a step of the process in FIG. 2, for determining whether or not it is necessary to change the image-capturing conditions.

FIG. 7 is a flowchart of a process performed by the image-capturable moving apparatus in the video recording process according to a second embodiment.

FIG. 8 is a diagram showing a scenario of background panning included in the shooting scenario list of the second embodiment.

FIG. 9 is a diagram showing an example of a video desired to capture in the scenario of background panning shown in FIG. 8.

FIG. 10 is a flowchart of a change necessity determination process performed in a step of the process in FIG. 7, for determining whether or not it is necessary to change the image-capturing conditions.

FIG. 11 is a flowchart of a process performed by the image-capturable moving apparatus in the video recording process according to a third embodiment.

FIG. 12A is a diagram showing an exposure amount-changing timing in a shooting scene in which the moving object has switched headlights thereof from low beam to high beam.

FIG. 12B is a diagram showing an exposure follow-up performed by an image capturing section at the exposure amount-changing timing.

FIG. 13A is a diagram showing an exposure amount-changing timing, which is similar to FIG. 12A.

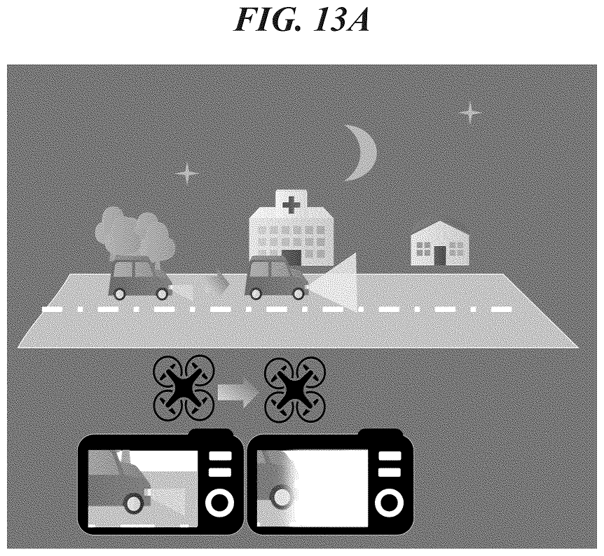

FIG. 13B is a diagram showing an exposure follow-up by a conventional video feedback method.

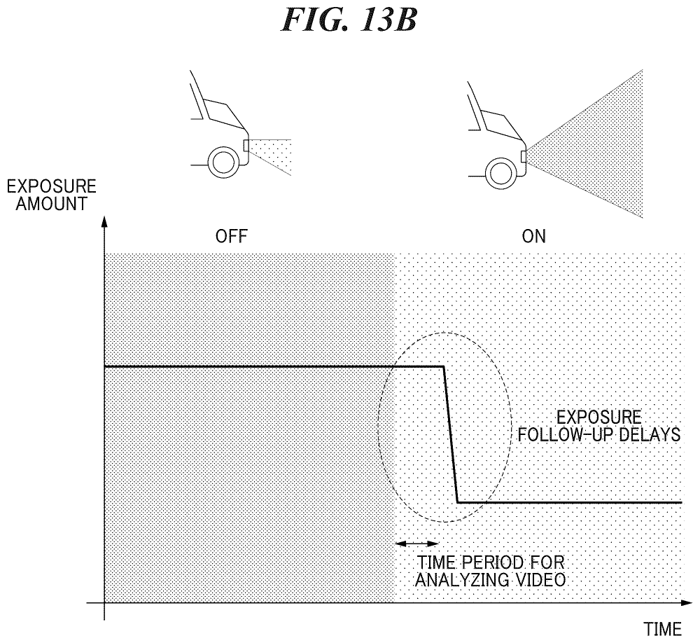

FIG. 14 is a flowchart of a process performed by the image-capturable moving apparatus in the video recording process according to a fourth embodiment.

FIG. 15A is a diagram showing an exposure amount-changing timing in a shooting scene in which the moving object repeatedly and alternately passes a sunny area and a shaded area.

FIG. 15B is a diagram showing processing performed by the image capturing section, for progressively changing an exposure condition in advance.

FIG. 16A is a diagram showing the exposure amount-changing timing, which is similar to FIG. 15A.

FIG. 16B is a diagram showing an exposure follow-up by the conventional video feedback method.

FIG. 17 is a diagram useful in explaining details of control of the exposure amount-changing timing shown in FIGS. 15A and 15B.

### DESCRIPTION OF THE EMBODIMENTS

The present invention will now be described in detail below with reference to the accompanying drawings showing embodiments thereof. Note that the present invention is not limited to the embodiments described below. Although a plurality of features are described in the embodiments, all of features described in the embodiments are not absolutely essential to the solution of the invention, and further, the plurality of features can be combined as desired. Further, in the accompanied drawings, the same or similar components are denoted by the same reference numerals, and redundant description thereof is omitted.

A first embodiment as the preferred embodiment of the present invention will be described below with reference to the drawings.

In the first embodiment, a desired moving image is shot by changing the position and posture of an image-capturable moving apparatus and image-capturing conditions, according to maneuvering instruction information of a moving object which involves maneuvering. Further, although in the first embodiment, as an example of the image-capturable moving apparatus, a drone which moves by flying in the air using e.g. a propeller will be described, the moving method is not limited to this. For example, the image-capturable moving apparatus can move on the ground using wheels or move in the water using a screw.

First, an information processing system according to the first embodiment will be described in detail with reference to the accompanied drawings.

The information processing system of the present embodiment includes an image-capturable moving apparatus 100 and a moving object 150 which is a shooting target of the image-capturable moving apparatus 100 and is connected to the image-capturable moving apparatus 100 in a wirelessly communicable state.

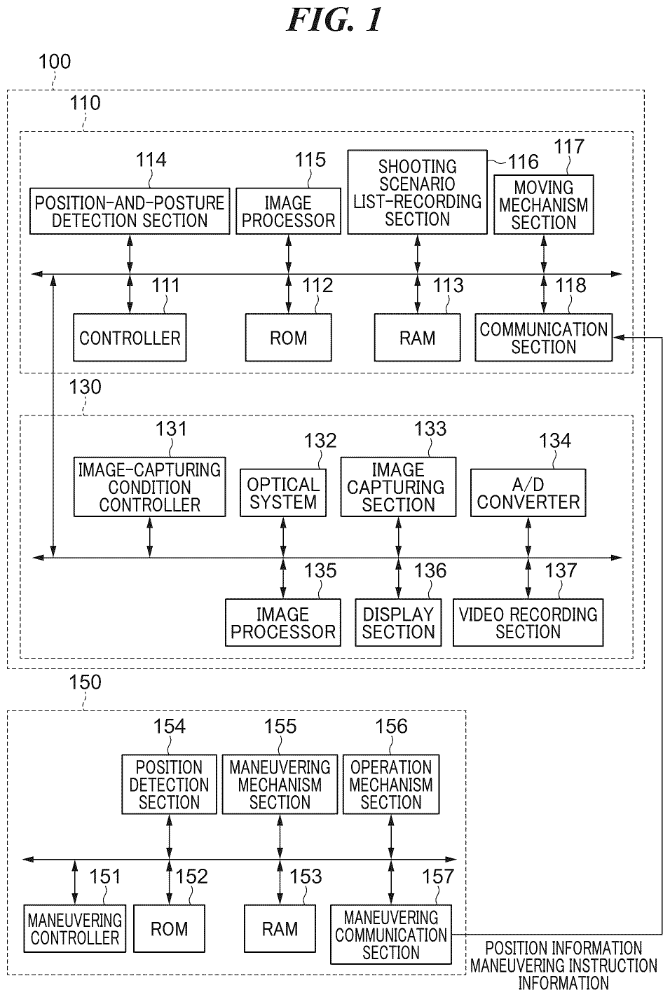

FIG. 1 is a block diagram showing an example of respective hardware configurations of the image-capturable moving apparatus 100 and the moving object 150.

Referring to FIG. 1, the image-capturable moving apparatus 100 is formed by an image capturing device 130 communicably connected via a bus and a mobile device 110 having the image capturing device 130 mounted thereon. Further, the moving object 150 is an object as a shooting target of the image capturing device 130 and moves by receiving a maneuvering instruction.

First, an example of the configuration of the mobile device 110 included in the image-capturable moving apparatus 100 will be described with reference to FIG. 1.

The mobile device 110 includes a controller 111, a read only memory (ROM) 112, a random access memory (RAM) 113, a position-and-posture detection section 114, an image processor 115, a shooting scenario list-recording section 116, a moving mechanism section 117, and a communication section 118. These blocks are communicably interconnected via a bus.

The controller 111 is e.g. a central processing unit (CPU), reads control programs concerning blocks included in the mobile device 110 and blocks included in the image capturing device 130, described hereinafter, from the ROM 112, loads the control programs into the RAM 113, and executes the loaded programs. With this, the controller 111 controls the operations of the blocks included in the image-capturable moving apparatus 100. Further, the controller 111 receives maneuvering instruction information and position information from the moving object 150 via the communication section 118. The maneuvering instruction information and the position information will be described hereinafter.

The ROM 112 is an electrically erasable and recordable nonvolatile memory and stores not only operation programs for the blocks included in the image-capturable moving apparatus 100, but also parameters and the like necessary for the operations of the blocks.

The RAM 113 is a rewritable volatile memory and is used for loading a program to be executed by the controller 111 or the like and temporarily storing data generated by the operation of each block included in the image-capturable moving apparatus 100.

The position-and-posture detection section 114 is a sensor for detecting a variety of information necessary for position-and-posture control and outputs detected position-and-posture information to the controller 111. As this sensor, a GPS sensor for detecting a position, a gyro sensor for detecting an angular speed, an acceleration sensor for detecting a change in speed, a magnetic sensor for detecting a direction, an air pressure sensor for detecting an altitude, an ultrasonic wave sensor for detecting a distance from a surrounding object, such as an object, and so forth, can be used. The controller 111 performs calculation according to the information detected by the position-and-posture detection section 114 and controls the position and posture of the mobile device 110.

The image processor 115 performs a variety of image processing operations concerning the position and posture of the mobile device 110 by analyzing a video captured by the image capturing device 130 and the information necessary for the position-and-posture control, which is acquired by the position-and-posture detection section 114. For example, the image processor 115 performs image processing for recognizing an object (such as the moving object 150) included in a video captured by the image capturing device 130, and the controller 111 controls the moving mechanism section 117 so as to track the object by using a result of the recognition processing. Note that as for the object recognition method and the object tracking method, known methods are used, and hence detailed description is omitted.

The shooting scenario list-recording section 116 records a shooting scenario list received from an external information processing apparatus, not shown, via the communication section 118. Note that when initial settings are made, the shooting scenario list can be recorded in the shooting scenario list-recording section 116 in advance.

The moving mechanism section 117 is formed by a buoyancy generation mechanism including a motor and a propeller. The controller 111 controls the position and posture of the mobile device 110 by maneuvering the moving mechanism section 117 according to the information detected by the position-and-posture detection section 114 and a result of object recognition performed by the image processor 115. With this, it is possible to perform tracking shooting in which an angle of view is controlled such that the moving object 150 is included within a range of a visual field captured by the image capturing device 130.

The communication section 118 performs communication based on a communication method determined by the standard, such as a wireless LAN.

Next, an example of the configuration of the image capturing device 130 included in the image-capturable moving apparatus 100 will be described with reference to FIG. 1.

The image capturing device 130 includes an image-capturing condition controller 131, an optical system 132, an image capturing section 133, an analog-to-digital (A/D) converter 134, an image processor 135, a display section 136, and a video recording section 137. These blocks are communicably interconnected via a bus.

The image-capturing condition controller 131 determines image-capturing conditions for image capturing performed by the optical system 132 and the image capturing section 133. The image-capturing conditions refer to an aperture value, a shutter speed, a frame rate, an ISO sensitivity, and so forth.

The optical system 132 is formed by a lens group including a zoom lens and a focus lens, and a diaphragm mechanism, and an object image is formed on an imaging surface of the image capturing section 133.

The image capturing section 133 is an image sensor, such as a CCD or CMOS sensor, which photoelectrically converts an optical image formed by the optical system 132 on the imaging surface of the image capturing section 133, and outputs the obtained analog image signals to the analog-to-digital converter 134.

The analog-to-digital converter 134 converts the input analog image signals to digital image data and outputs the digital image data. The digital image data output from the analog-to-digital converter 134 is temporarily stored in the RAM 113.

The image processor 135 performs a variety of image processing operations on image data stored in the RAM 113. Specifically, the image processor 135 applies a variety of image processing operations for developing, displaying, and recording digital image data, including demosaicing processing, noise reduction processing, white balance correction processing, and gamma processing. The image processing operations also include processing for generating video data from image data stored in the RAM 113 on a time-series basis.

The video recording section 137 records data including video data generated by the image processor 135 in a recording medium incorporated therein.

The display section 136 includes a display device, such as a liquid crystal display (LCD), and displays an image stored in the RAM 113 and an image recorded in the video recording section 137 on the display device.

Next, an example of the configuration of the moving object 150 will be described with reference to FIG. 1. In the present embodiment, the image-capturable moving apparatus 100 captures an image of the moving object 150 by using the image capturing device 130 to generate image data. Further, in the present embodiment, a car will be described as an example of the moving object 150, but the moving object 150 is not limited to this. For example, the moving object 150 can be any suitable object which moves while being maneuvered by a driver or operator, such as a motorbike, a ship, a plane, or a train. Not that the moving object 150 can be an apparatus that is not maneuvered by an on-board person, but performs automatic maneuvering by recognizing a surrounding condition. Further, the moving object 150 can be an apparatus that is not maneuvered by an on-board person, but is maneuvered by remote control, such as a radio-controlled car. Note that as the automatic maneuvering method and the maneuvering method using remote control, known maneuvering methods are employed, and detailed description thereof is omitted.

The moving object 150 includes a maneuvering controller 151, a read only memory (ROM) 152, a random access memory (RAM) 153, a position detection section 154, a maneuvering mechanism section 155, an operation mechanism section 156, and a maneuvering communication section 157. These blocks are communicably interconnected via a bus.

The maneuvering controller 151 is e.g. a CPU, reads control programs concerning the blocks included in the moving object 150 from the ROM 152, loads the control programs into the RAM 153, and executes the loaded programs. With this, the maneuvering controller 151 controls the operations of the blocks included in the moving object 150. Further, the maneuvering controller 151 transmits maneuvering instruction information and position information to the mobile device 110 via the maneuvering communication section 157. The maneuvering instruction information and the position information will be described hereinafter.

The ROM 152 is an electrically erasable and recordable nonvolatile memory and stores not only operation programs for the blocks included in the moving object 150, but also parameters and the like necessary for the operations of the blocks.

The RAM 153 is a rewritable volatile memory and is used for loading a program to be executed by the maneuvering controller 151 or the like and temporarily storing data e.g. generated by the operation of each block included in the moving object 150.

The position detection section 154 has a plurality of sensors for detecting a three-dimensional position and outputs information on a three-dimensional position calculated from information detected by the sensors to the maneuvering controller 151. As the plurality of sensors, for example, a GPS sensor for detecting a two-dimensional plane position, an air pressure sensor for detecting an altitude, and so forth can be used. The position detection section 154 calculates three-dimensional position information of the moving object 150 by using these sensors. Note that as the sensor for detecting an altitude, the GPS sensor can be used.

The maneuvering mechanism section 155 is a mechanism used by an on-board person to instruct maneuvering of the moving object 150. Specifically, the maneuvering mechanism section 155 is comprised of movable mechanisms, such as a steering wheel, an accelerator pedal, a brake pedal, a direction indicator lever, a windscreen wiper lever, and a light switch. Whenever the passenger provides an instruction by operating the maneuvering mechanism section 155, the maneuvering instruction information is output to the operation mechanism section 156.

The operation mechanism section 156 drives a variety of mechanisms, not shown, included in the moving object 150 (movable mechanisms, such as front wheels, an engine, and headlights, and notification mechanisms, such as direction indicator lights, brake lamps, and a horn) according to the maneuvering instruction information output from the maneuvering mechanisms section 155. Specifically, as the maneuvering instruction information, there can be mentioned information for instructing a position and an operation of the moving object 150. More specifically, as the maneuvering instruction information, there can be mentioned information for instructing a speed and an orientation of the moving object 150, operations of the movable mechanisms, a notification using sound and light, and light emission from a light source. For example, in a case where a steering angle of the steering wheel is output from the maneuvering mechanism section 155 as the maneuvering instruction information, the operation mechanism section 156 transfers this maneuvering instruction information to an actuator which controls the travelling direction of the moving object 150 to change the direction of the front wheels. Further, in a case where a step-on amount of the accelerator pedal is output from the maneuvering mechanism section 155 as the maneuvering instruction information, the operation mechanism section 156 transfers this maneuvering instruction information to an actuator which controls the acceleration of the moving object 150 to increase the engine speed. Further, there is a case where an operation of opening/closing a window, a light switching operation, a direction indicator lever operation, a step-on operation of the brake pedal, a horn operation, or the like is output from the maneuvering mechanism section 155 as the maneuvering instruction information. In this case, the operation mechanism section 156 opens/closes the window (movable mechanism), lights the head lights, the direction indicator lights, the brake lamps, or the like, or generates a horn sound, according to associated maneuvering instruction information.

The maneuvering communication section 157 performs communication based on a communication method determined by the standard, such as a wireless LAN.

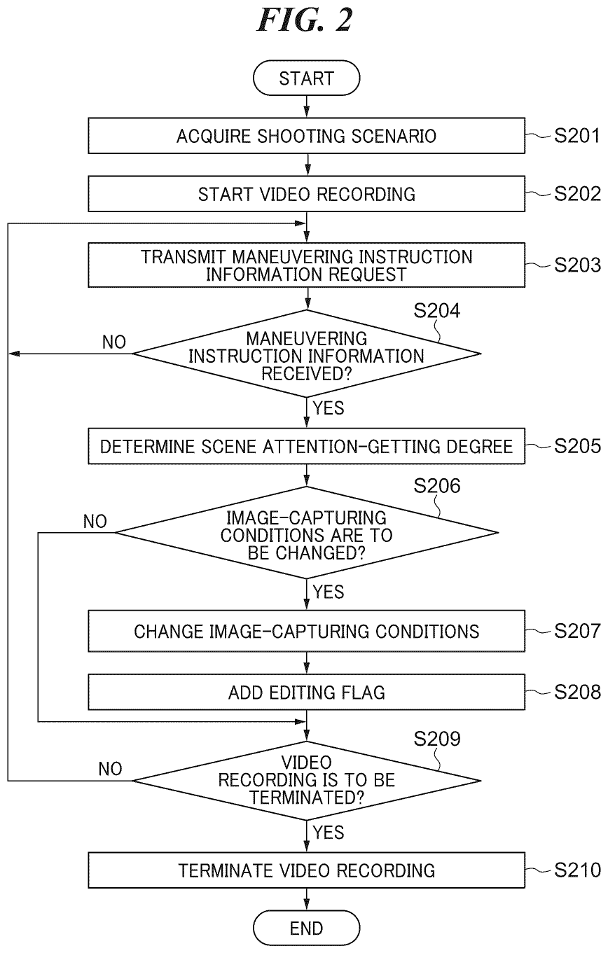

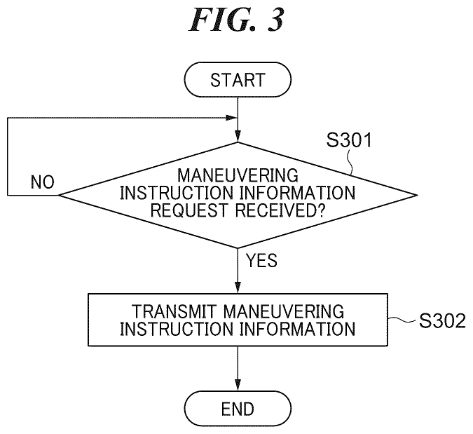

Next, a video recording process for recording a video of the moving object 150, according to the present embodiment, will be described in detail with reference to FIGS. 2 and 3. FIG. 2 shows a process performed by the image-capturable moving apparatus 100 in the video recording process, and FIG. 3 shows a process performed by the moving object 150 in the video recording process.

First, the process in FIG. 2, performed by the image-capturable moving apparatus 100, will be described. The present process is executed by the controller 111 included in the mobile device 110, which loads a program stored in the ROM 112 into the RAM 113. Further, in the following description, when an executing entity other than the controller 111 executes a step, in actuality, the controller 111 controls the executing entity.

First, in a step S201, the controller 111 (shooting scenario selection unit) acquires (selects) a shooting scenario included in the shooting scenario list recorded in the shooting scenario list-recording section 116. The shooting scenario list can be received from an information processing apparatus, not shown, via the communication section 118, and be recorded in the shooting scenario list-recording section 116, or alternatively can be recorded in the shooting scenario list-recording section 116 in advance.

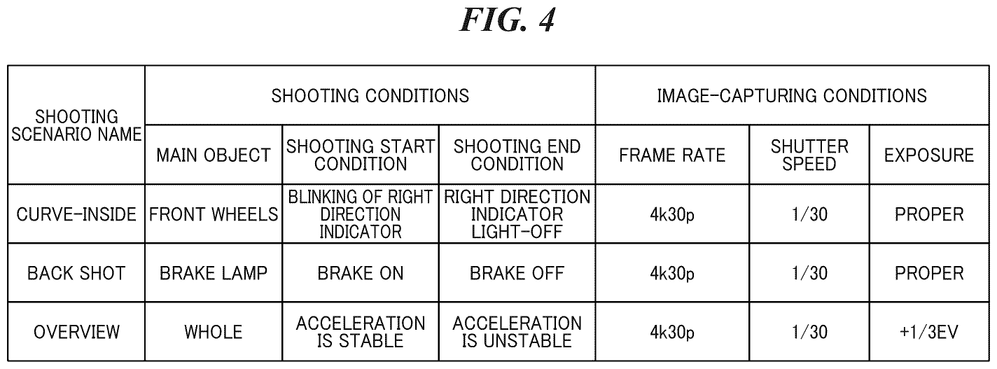

Here, the shooting scenario list will be described. The shooting scenario list refers to such a list as shown in FIG. 4, which describes shooting scenarios each including shooting conditions and image-capturing conditions of the image capturing device 130. The image-capturable moving apparatus 100 performs shooting according to the shooting conditions and the image-capturing conditions, described in the shooting scenario. As shown in FIG. 4, in the shooting scenario list, as the shooting conditions of each shooting scenario, a main object, and a shooting start condition and a shooting end condition, which are determined based on the maneuvering instruction information, are described, and as the image-capturing conditions, settings of a frame rate, a shutter speed, and exposure are described. For example, in a curve-inside scenario indicated in FIG. 4, when maneuvering instruction information indicating blinking of a right direction indicator is received from the moving object 150, image-capturing is started. Note that the main object is not necessarily required to be included in the shooting conditions of each shooting scenario.

Referring again to FIG. 2, in a step S202, the controller 111 periodically receives the maneuvering instruction information transmitted from the moving object 150. Then, if the controller 111 determines that the shooting start condition in the shooting scenario acquired in the step S201 is satisfied based on the received maneuvering instruction information, the controller 111 causes the image capturing device 130 to start recording of a video with the image-capturing conditions described in the shooting scenario.

In a step S203, the controller 111 (acquisition unit) transmits a maneuvering instruction information request to the moving object 150 via the communication section 118.

Here, the process in FIG. 3, which is performed by the moving object 150, will be described. The present process is executed by the maneuvering controller 151 included in the moving object 150, which loads a program stored in the ROM 152 into the RAM 153.

First, in a step S301, the maneuvering controller 151 determines whether or not the maneuvering instruction information request transmitted from the mobile device 110 in the step S203 has been received. If the maneuvering instruction information request has been received (YES to S301), the process proceeds to a step S302, and the maneuvering controller 151 transmits the maneuvering instruction information to the mobile device 110 via the maneuvering communication section 157, followed by terminating the present process. On the other hand, if the maneuvering instruction information request has not been received (NO to S301), the determination processing in the step S301 is repeated until the maneuvering instruction information request is received.

The process performed by the moving object 150 is as described above.

Referring again to FIG. 2, in a step S204, the controller 111 included in the mobile device 110 determines whether or not the maneuvering instruction information transmitted from the moving object 150 in the step S302 in FIG. 3 has been received. If the maneuvering instruction information has been received (YES to S204), the controller 111 transmits the received maneuvering instruction information to the image-capturing condition controller 131 included in the image capturing device 130 and proceeds to a step S205. On the other hand, if the maneuvering instruction information has not been received (NO to S204), the process returns to the step S203, and the controller 111 transmits the maneuvering instruction information request to the moving object 150 again.

In the step S205, the image-capturing condition controller 131 (scene attention-getting degree determination unit) included in the image capturing device 130 determines a scene attention-getting degree based on the maneuvering instruction information transmitted from the controller 111.

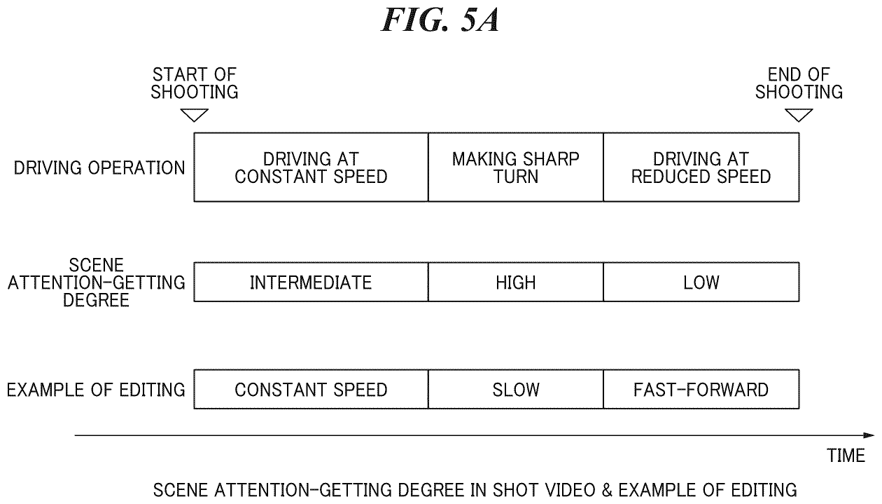

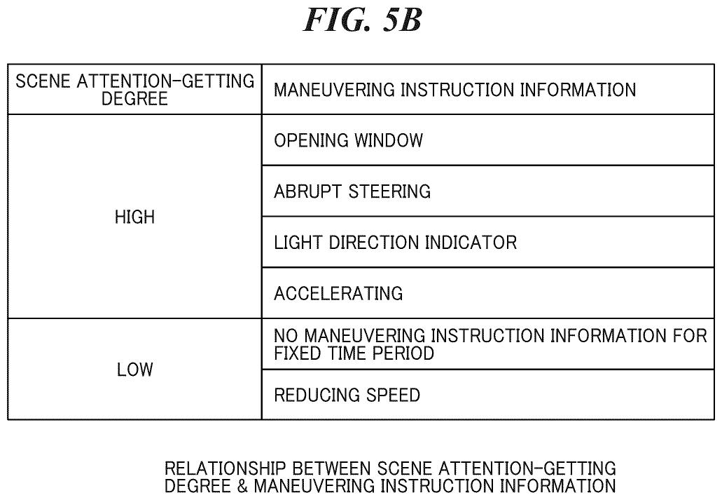

Here, the scene attention-getting degree will be described with reference to FIGS. 5A and 5B. The scene attention-getting degree refers to a magnitude of a degree of attention to each shooting scene of a video (hereinafter referred to as a series of shot video images) started to be recorded by the image capturing device 130 in the step 202.

FIG. 5A is a diagram showing a relationship between changes in the scene attention-getting degree in a shot video and an example of video editing.

As shown in FIG. 5A, in the series of shot video images, it is generally considered that a shooting scene in which a car is turning along a sharp curve is high in the scene attention-getting degree, whereas a shooting scene in which a deceleration operation is performed is low in the scene attention-getting degree. Therefore, when editing the video, a reproduction speed is changed according to such a scene attention-getting degree. Specifically, in a scene having a high scene attention-getting degree, the reproduction speed is reduced to reproduce the video in slow motion, and inversely, in a scene having a low scene attention-getting degree, the reproduction speed is increased to fast-forward the video. By performing such video editing, it is possible to generate an excellent moving image having a high product quality, in which the shooting scene having a high attention-getting degree is emphasized.

FIG. 5B is a diagram showing a relationship between the scene attention-getting degree and the maneuvering instruction information, which are held by the image-capturing condition controller 131 included in the image capturing device 130 in advance.

As shown in FIG. 5B, the high attention-getting degree is set to maneuvering instruction information indicating for opening/closing a window, making a sharp turn, blinking the direction indicator, accelerating, and performing drift running. On the other hand, the low scene attention-getting degree is set to maneuvering instruction information indicating that no maneuvering instruction has been provided for a predetermined time period or more or that the speed is reduced. An intermediate scene attraction-getting degree is set to other maneuvering instruction information.

The scene attention-getting degree is as described above.

Referring again to FIG. 2, in a step S206, the image-capturing condition controller 131 included in the image capturing device 130 executes a change necessity determination process in a step S206, for determining, based on the scene attention-getting degree determined in the step S205, whether or not it is necessary to change the image-capturing conditions.

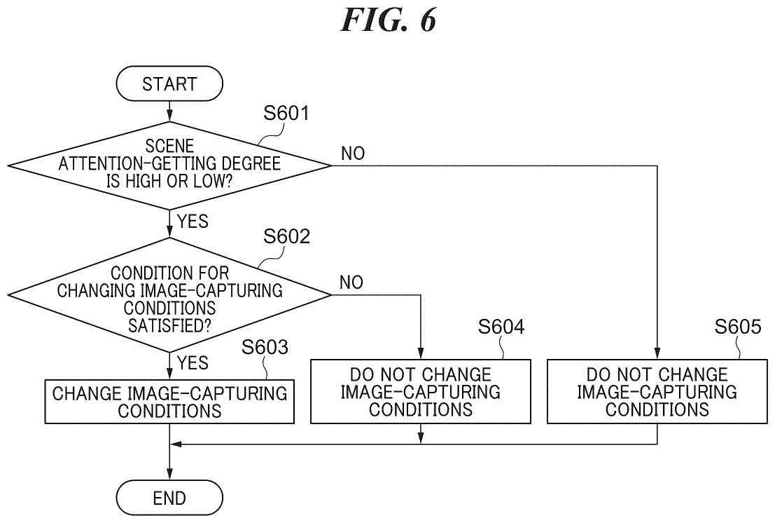

Here, the change necessity determination process for the image-capturing conditions, which is executed in the step S206, will be described with reference to FIG. 6.

First, in a step S601, the image-capturing condition controller 131 determines whether or not the scene attention-getting degree determined in the step S205 is high or low, or intermediate. If the scene attention-getting degree is high or low (YES to S601), the process proceeds to a step S602. On the other hand, if the scene attention-getting degree is intermediate (NO to S601), the process proceeds to a step S605, wherein the image-capturing conditions are set not to be changed, followed by terminating the present process.

Next, in the step S602, the image-capturing condition controller 131 determines whether or not a condition for changing the image-capturing conditions is satisfied. For example, in a case where the image-capturing conditions have already been changed and image-capturing is being performed, a case where the same scene (or a slow-motion scene) has been shot a predetermined number of times or more, or a case where another scene having high urgency is being shot, such as a case where a landmark is being shot, the image-capturing conditions are not changed. If the condition for changing the image-capturing conditions is not satisfied (NO to S602), the process proceeds to a step S604, wherein the image-capturing conditions are not changed, followed by terminating the present process. On the other hand, if the condition for changing the image-capturing conditions is satisfied (YES to S602), the process proceeds to a step S603, wherein the image-capturing conditions are changed, followed by terminating the present process.

The detailed processing flow of the step S206 is as described above.

Referring again to FIG. 2, if the answer to the question of the step S206 is negative (NO), the process proceeds to a step S209, whereas if the answer to the question of the step S206 is affirmative (YES), the process proceeds to a step S207.

In the step S207, the image-capturing condition controller 131 (image capturing control unit) included in the image capturing device 130 controls the image capturing section 133 to change the image-capturing conditions based on a result of the determination in the step S206. Specifically, the frame rate at the time of image-capturing is changed according to the scene attention-getting degree. That is, after the image-capturing is started at the frame rate described in the shooting scenario, if it is determined that the scene attention-getting degree is high, the image-capturing condition controller 131 performs control, while expecting that slow motion reproduction is performed at the time of editing the video, to increase the frame rate at the time of image-capturing so as to prevent the video from unnaturally appearing even when slow motion reproduction is performed. On the other hand, after the image-capturing is started, if it is determined that the scene attention-getting degree is low, the image-capturing condition controller 131 performs control, while expecting that fast-forward reproduction is performed at the time of editing the video, to reduce the frame rate at the time of image-capturing. In addition thereto, the image-capturing condition controller 131 notifies the start of changing the image-capturing conditions to the video recording section 137 included in the image capturing device 130.

In a step S208, the video recording section 137 included in the image capturing device 130 adds an editing flag to the acquired frame data upon receipt of the notification of the start of changing the image-capturing conditions from the image-capturing condition controller 131 in the step S206. Here, in a case where a changed one of the image-capturing conditions is the control to increase the frame rate at the time of image-capturing, a flag indicating that the video is edited such that reproduction in slow motion is performed when editing the video is provided. Further, in a case where the changed one of the image-capturing conditions is the control of reducing the frame rate at the time of image-capturing, a flag for causing fast-forward reproduction to be performed at the time of editing the video is added.

In the step S209, the controller 111 determines whether or not to terminate video recording. If the latest received maneuvering instruction information satisfies the shooting end condition in the shooting scenario acquired in the step S201 (YES to S209), the process proceeds to a step S210, wherein video recording by the image-capturable moving apparatus 100 is terminated, followed by terminating the present process. On the other hand, if the latest received maneuvering instruction information does not satisfy the shooting end condition in the shooting scenario acquired in the step S201 (NO to S209), the process returns to the step S203, and video recording is continued.

As described above, by the video recording process according to the present embodiment, the image-capturing conditions are changed according to the maneuvering instruction information, and hence it is possible to more quickly change the image-capturing conditions than in the conventional method in which the image-capturing conditions are changed according to image analysis information, and as a result, it is possible to acquire an excellent video having a high product quality. Further, by using the editing flag, when reproducing a video recorded by performing the present process, it is possible to set the reproduction speed at an optimum timing.

Note that although in the example shown in FIGS. 5A and 5B, the scene attention-getting degree is determined based on the maneuvering instruction information in the step S205, the scene attention-getting degree can be determined by further using information other than the maneuvering instruction information. For example, acceleration/deceleration information of an oncoming car is acquired, and the scene attention-getting degree in a scene in which the moving object 150 and the oncoming car pass each other can be set according to the acceleration/deceleration information. Further, in a case where a window of the moving object 150 is open, and a face of an on-board person maneuvering the moving object 150 is detected, the scene attention-getting degree can be set to high. Further, information on a landmark is detected from map information, and the scene attention-getting degree can be set to high in a scene in which the moving object 150 passes the landmark in the vicinity thereof. Further, in a case where the maneuvering instruction information cannot be received, the scene attention-getting degree can be determined based on the existing image analysis information and map information.

Further, although in the present embodiment, the control to increase the frame rate at the time of image-capturing is performed in a case where the scene attention-getting degree is high, the control of the image-capturing conditions is not limited to this. For example, in a scene having a high scene attention-getting degree, the control to acquire a RAW moving image so as to enable detailed editing or the control to open the aperture so as to emphasize the main object by blurring the background can be performed. Similarly, in a case where the scene attention-getting degree is low, not only the control to reduce the frame rate at the time of image-capturing, described in the present embodiment, but also the control to increase a compression rate at the time of recording or the control to terminate image-capturing in anticipation of the scene being cut at the time of editing the video can be performed.

Although in the present embodiment, the process in FIG. 2 is performed by the controller 111 of the image-capturable moving apparatus 100, the process in FIG. 2 can be executed by a server (information processing apparatus) which is different from the image-capturable moving apparatus 100 and the moving object 150 and is communicably connected to these. In this case, the shooting scenario list and the information of the table shown in FIG. 5B are stored in the server in advance, and an instruction for changing image-capturing conditions according to the maneuvering instruction information from the moving object 150 is transmitted from the server to the image-capturable moving apparatus 100.

Further, the process in FIG. 2 can be performed by the maneuvering controller 151 of the moving object 150. In this case, the shooting scenario list and the information of the table shown in FIG. 5B are stored in the ROM 152 in advance, and an instruction for changing image-capturing conditions according to the maneuvering instruction information stored in the moving object 150 is transmitted from the moving object 150 to the image-capturable moving apparatus 100.

A second embodiment as the preferred embodiment of the present invention will be described below with reference to the drawings.

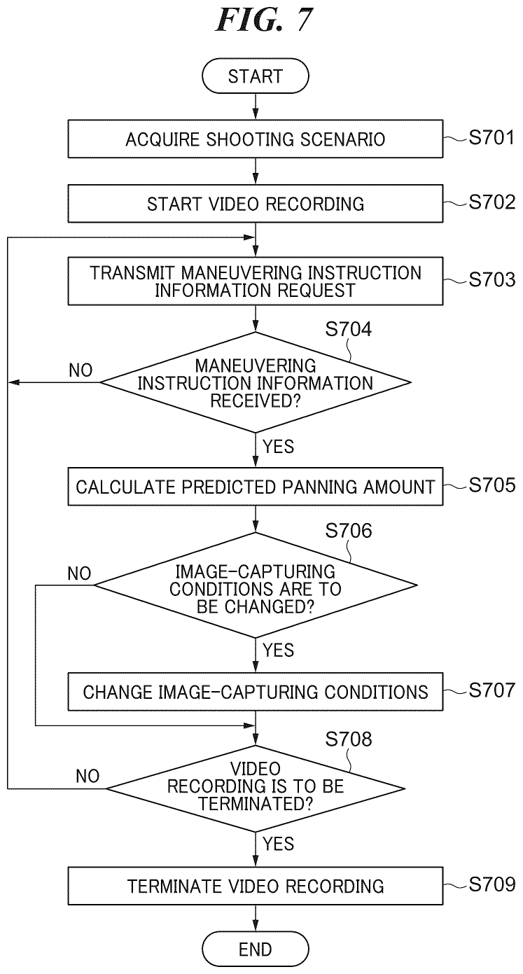

First, a video recording process for recording a video of the moving object 150, according to the present embodiment, will be described with reference to FIG. 7.

The present embodiment is characterized in that the image-capturing condition controller 131 of the image capturing device 130 controls the shutter speed out of the image-capturing conditions at the time of image-capturing, based on the maneuvering instruction information received via the communication section 118.

FIG. 7 is a flowchart of the video recording process performed by the image-capturable moving apparatus 100 in the video recording process according to the present embodiment. The present process is executed by the controller 111 included in the mobile device 110, which loads a program stored in the ROM 112 into the RAM 113. Further, in the following description, when an executing entity other than the controller 111 executes a step, in actuality, the controller 111 controls the executing entity.

First, in a step S701, the controller 111 acquires a shooting scenario included in the shooting scenario list recorded in the shooting scenario list-recording section 116. The shooting scenario list can be received from an information processing apparatus, not shown, via the communication section 118 and recorded in the shooting scenario list-recording section 116, or can be recorded in the shooting scenario list-recording section 116 in advance.

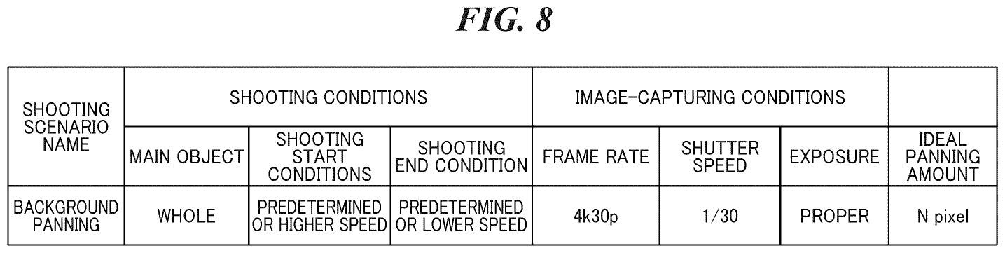

In the present embodiment, a case where a scenario of background panning, shown in FIG. 8, is included in the shooting scenario list will be described. The scenario of background panning is a scenario for performing image-capturing while panning the background when the mobile device 110 performs shooting while tracking the moving object 150, and includes an ideal background-panning amount set therefor.

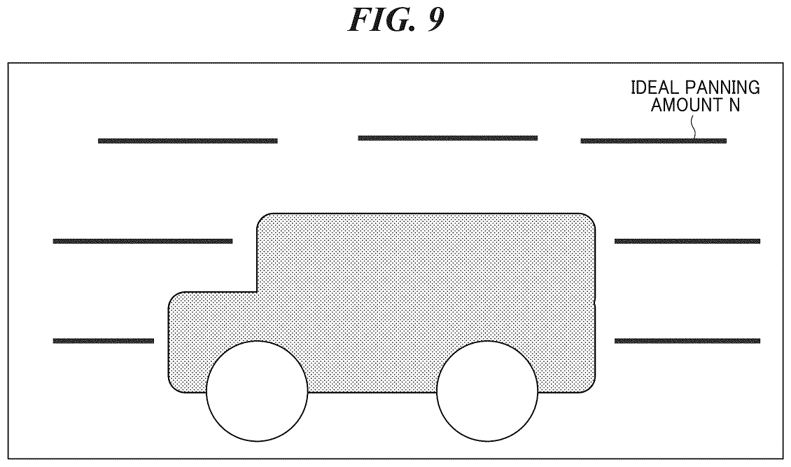

FIG. 9 is a diagram showing an example of a video desired to be acquired based on the scenario of background panning. As shown in FIG. 9, the present embodiment aims to acquire an excellent video having a high product quality, in which the ideal background-panning amount becomes equal to N (pixels).

Steps S702 to S704 in FIG. 7 are the same as the steps S202 to S204 in FIG. 2 in the first embodiment, and hence description thereof is omitted.

In a step S705, the image-capturing condition controller 131 (predicted panning amount calculation unit) included in the image capturing device 130 calculates a predicted panning amount of the moving object 150 based on the maneuvering instruction information transmitted from the controller 111. The predicted panning amount is an estimated amount of the panning amount with respect to a speed of the moving object 150, which is predicted from the maneuvering instruction information, such as a step-on amount of the acceleration pedal or brake pedal. The predicted panning amount N_pred (pixels) is calculated by the following equation (1):

$$N\_pred = f ( v , t ) \qquad ( 1 )$$

Here, v represents a predicted speed amount of the moving object 150 and is calculated based on the maneuvering instruction information. Further, t represents a shutter speed at the time of image-capturing. Note that other elements necessary for calculating the panning amount of the image surface, such as a distance from the image-capturable moving apparatus 100 to the moving object 150, lens parameters, and a pixel pitch, are denoted by a predetermined relational expression in the present embodiment, and are not included in the variables of the function f.

The predicted panning amount is as described above.

Referring again to FIG. 7, in a step S706, the image-capturing condition controller 131 (ideal panning amount acquisition unit) included in the image capturing device 130, first, acquires the ideal panning amount N from the scenario of background panning, which is acquired in the step S701. Next, the image-capturing condition controller 131 performs the change necessity determination process for the image-capturing conditions, based on the predicted panning amount N_pred calculated in the step S705 and the ideal panning amount N.

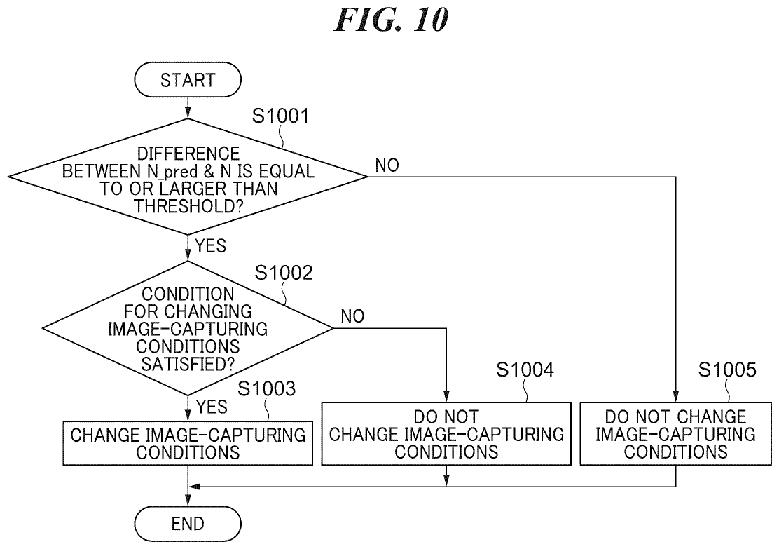

Here, the change necessity determination process for the image-capturing conditions, which is executed in the step S706, will be described with reference to FIG. 10.

First, in a step S1001, the image-capturing condition controller 131 determines whether or not a difference between the predicted panning amount N_pred and the ideal panning amount N is equal to or larger than a predetermined threshold value.

If the difference between the predicted panning amount N_pred and the ideal panning amount N is equal to or larger than the predetermined threshold value (YES to S1001), the image-capturing condition controller 131 determines that it is preferable to change the image-capturing conditions, particularly the shutter speed, and proceeds to a step S1002. This is because if the panning amount of the shot video is smaller than the ideal panning amount by the predetermined threshold value or more, there is a high possibility that the product quality is degraded, and further, if the panning amount of the captured image is larger than the ideal panning amount by the predetermined threshold value or more, even a fine movement of the shot object is also panned and there is a high possibility that the product quality is degraded.

On the other hand, if the difference between the predicted panning amount N_pred and the ideal panning amount N is smaller than the predetermined threshold value (NO to S1001), the process proceeds to a step S1005, wherein it is determined that a change of the image-capturing conditions is not required, followed by terminating the present process.

In the present embodiment, specifically, if the predicted panning amount N_pred is smaller than the ideal panning amount N by the predetermined threshold value or more, it is determined that the current shutter speed is too shorter than a shutter speed at which the ideal panning amount is obtained, and the control to increase the shutter speed is performed. On the other hand, if the predicted panning amount N_pred is larger than the ideal panning amount N by the predetermined threshold value or more, it is determined that the current shutter speed is too longer than the shutter speed at which the ideal panning amount is obtained, and the control to reduce the shutter speed is performed.

Next, in the step S1002, the image-capturing condition controller 131 determines whether or not the condition for changing the image-capturing conditions is satisfied. For example, in a case where the background-panning moving image has already been shot a predetermined number of times or more, or in a case where the frame rate exceeds the frame rate at the time of image-capturing by increasing the shutter speed, the image-capturing conditions are not changed. Further, in a case where a non-exposure period becomes a predetermined time period or more by reducing the shutter speed, or in a case where the ISO sensitivity becomes a predetermined value or higher, the image-capturing conditions are not changed, either. If the condition for changing the image-capturing conditions is not satisfied (NO to S1002), the process proceeds to a step S1004, wherein the image-capturing conditions are not changed, followed by terminating the present process. On the other hand, if the condition for changing the image-capturing conditions is satisfied (YES to S1002), the process proceeds to a step S1003, wherein the image-capturing conditions are changed, followed by terminating the present process.

The detailed processing in the step S706 is as described above.

Referring again to FIG. 7, if the answer to the question of the step S706 is negative (NO), the process proceeds to a step S708, whereas if the answer to the question of the step S706 is affirmative (YES), the process proceeds to a step S707.

In the step S707, the image-capturing condition controller 131 included in the image capturing device 130 controls the image capturing section 133 to change the image-capturing conditions based on a result of the determination in the step S706, and the process proceeds to the step S708.

In the step S708 in FIG. 7, the controller 111 determines whether or not to terminate video recording. Specifically, if the latest acquired maneuvering instruction information satisfies the shooting end condition in the shooting scenario acquired in the step S701 (YES to S708), the process proceeds to a step S709, wherein the controller 111 terminates video recording performed by the image-capturable moving apparatus 100, followed by terminating the present process. On the other hand, if the latest acquired maneuvering instruction information does not satisfy the shooting end condition in the shooting scenario acquired in the step S701 (NO to S708), the process returns to the step S703, and video recording is continued.

As described above, with the video recording process according to the present embodiment, the image-capturing conditions are changed according to the maneuvering instruction information, and hence it is possible to more quickly change the shutter speed than in the conventional method in which the image-capturing conditions are changed according to image analysis information, and as a result, it is possible to acquire an excellent video having a high product quality.

Note that although in the present embodiment, the control to change the shutter speed is not performed in a case where the frame rate exceeds the frame rate at the time of image-capturing by increasing the shutter speed, the control of the image-capturing conditions is not limited to this. For example, control to change not only the shutter speed but also the frame rate or control to change not only the shutter speed but also the aperture value can be performed. Further, a flag for performing video editing such that a plurality of consecutives frames are synthesized to thereby cause a pseudo increase of the shutter speed to be added to frame data acquired by the video recording section 137.

Further, although in the present embodiment, the control of the image-capturing conditions is performed only based on the maneuvering instruction information, the control of the image-capturing conditions is not limited to this. For example, in a situation where it is difficult to receive the maneuvering instruction information, the predicted panning amount can be calculated e.g. from a motion vector obtained by image analysis in the step S705.

Next, a third embodiment as the preferred embodiment of the present invention will be described below with reference to associated drawings.

The present embodiment is characterized in that the image-capturing condition controller 131 of the image capturing device 130 controls the exposure condition out of the image-capturing conditions at the time of image-capturing, based on the maneuvering instruction information received via the communication section 118.

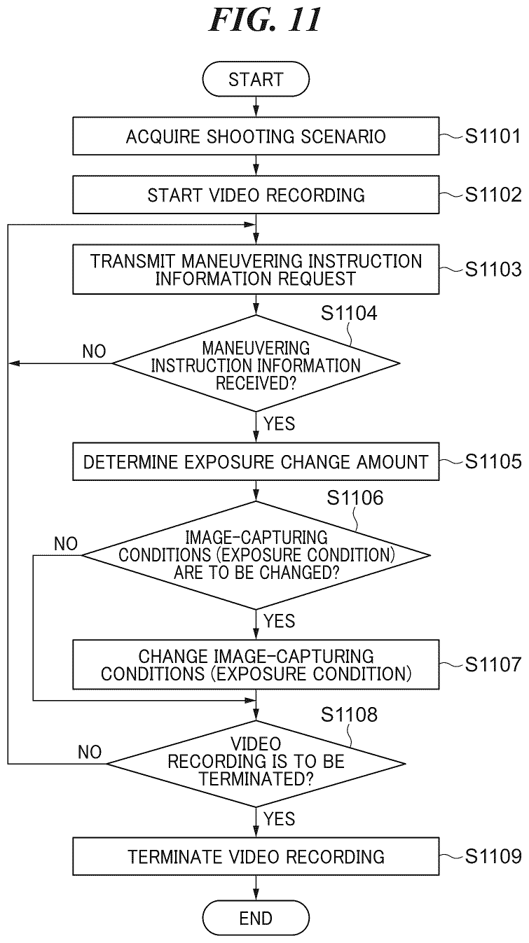

FIG. 11 is a flowchart of a process performed by the image-capturable moving apparatus 100 in the video recording process according to the present embodiment. The present process is executed by the controller 111 included in the mobile device 110, which loads a program stored in the ROM 112 into the RAM 113. Further, in the following description, when an executing entity other than the controller 111 executes a step, in actuality, the controller 111 controls the executing entity.

Steps S1101 and S1102 are the same as the steps S201 and S202 in FIG. 2 in the first embodiment, and hence description thereof is omitted.

In a step S1103, the controller 111 included in the mobile device 110 transmits a maneuvering instruction information request to the moving object 150 via the communication section 118.

In the present embodiment, as the maneuvering instruction information, for example, instruction information for controlling on/off of the headlights or switching between high beam and low beam of the moving object 150 is received. Note that the maneuvering instruction information is not limited to the instruction information with respect to the head lights, but instruction information for the other items, which leads to a change in the exposure condition of the moving object 150 and its vicinity, such as instruction information concerning indoor lights.

A step S1104 is the same as the step S204 in FIG. 2 in the first embodiment, and hence description thereof is omitted.

In a step S1105, the image-capturing condition controller 131 included in the image capturing device 130 determines an exposure change amount based on the maneuvering instruction information transmitted from the controller 111. The exposure change amount refers to a change amount of exposure, which is determined in advance in association with predetermined maneuvering instruction information, such as instruction information for controlling on/off of the headlights or switching between high beam and low beam of the moving object 150. Note that correspondence information indicating correspondence between the maneuvering instruction information and the exposure change amount has been stored in the ROM 112 of the mobile device 110 in advance, and the image-capturing condition controller 131 determines the exposure change amount using this correspondence information.

In a step S1106, the image-capturing condition controller 131 included in the image capturing device 130 determines, based on the exposure change amount determined in the step S1105, whether or not it is necessary to change the exposure condition of the image capturing device 130. If the exposure change amount is equal to or larger than a threshold value, it is determined that it is necessary to change the image-capturing conditions (YES to S1106), and the process proceeds to a step S1107, wherein the image-capturing condition controller 131 executes exposure condition-changing processing for changing the image-capturing conditions (exposure condition), and then the process proceeds to a step S1108. On the other hand, if the exposure change amount is smaller than the threshold value, it is determined that it is unnecessary to change the image-capturing conditions (NO to S1106), and the process proceeds to the step S1108.

Here, the exposure condition-changing processing executed in the step S1107 will be described in detail with reference to drawings.

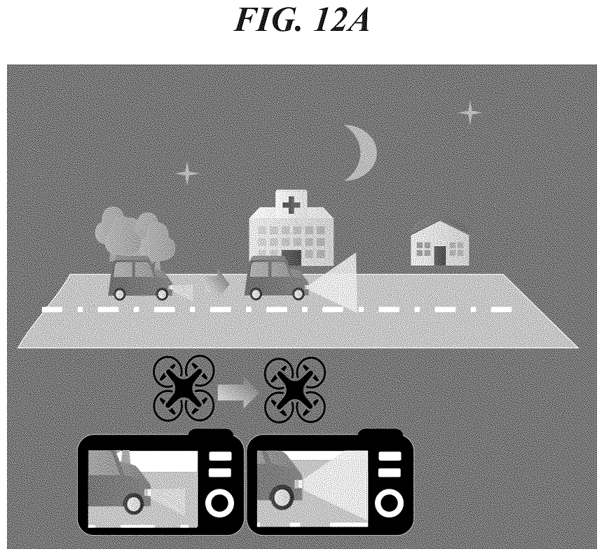

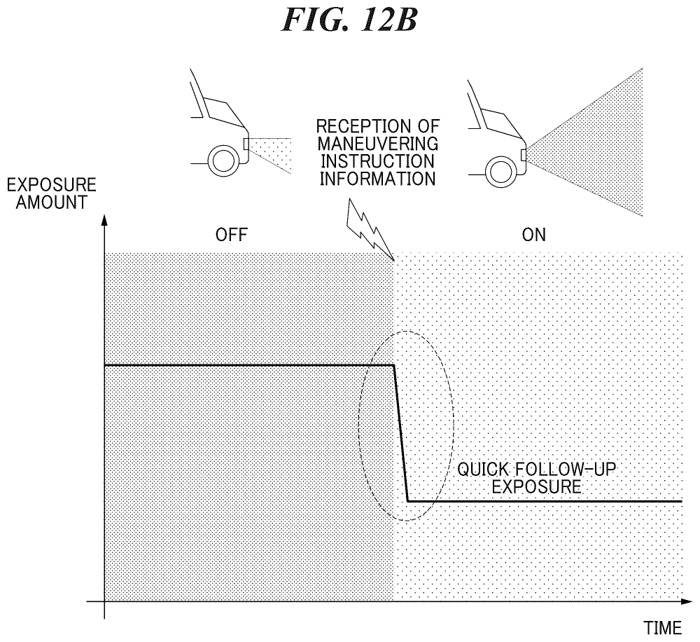

For example, as shown in FIG. 12A, let us consider a scene in which the moving object 150 is shot by using the image capturing device 130 under a dark condition, such as during the night. When an operation, such as switching of the headlights from low beam to high beam, is performed by the moving object 150 during image-capturing, the mobile device 110 acquires the maneuvering instruction information indicating this operation. At this time, upon acquisition of the maneuvering instruction information, the image-capturing condition controller 131 acquires the exposure change amount associated with the maneuvering instruction from the ROM 112, and if the acquired exposure change amount is equal to or larger than the threshold value, the image-capturing condition controller 131 executes the exposure condition-changing processing in the step S1107. Therefore, an exposure follow-up by the image capturing section 133 is quickly performed as shown in FIG. 12B.

If the exposure condition of the image capturing section 133 is changed by using a method of analyzing the video in similar scenes and feeding back a result of the analysis, it takes some time for the mobile device 110 to analyze the video, which causes a delay in the exposure follow-up of the image capturing section 133 with respect to the change in the luminance of the moving object 150 and its vicinity. As a result, a lot of frames with improper exposure are generated, which degrades the quality of the video. On the other hand, as in the present embodiment, by changing the exposure condition based on the maneuvering instruction information, as shown in FIG. 12B, it is possible to quickly perform the exposure follow-up with respect to the rapid change in the exposure of the moving object 150 and its vicinity.

In the present embodiment, the exposure condition is changed by changing the ISO sensitivity of the image capturing section 133. In doing this, in a case where the ISO sensitivity is set to the lower limit of change and cannot be further reduced, but it is necessary to further reduce the exposure, as in a case where the ISO sensitivity before the change is equal to 100, the exposure is reduced by controlling another exposure parameter, such as the aperture value. Further, in a case where the ISO sensitivity is set to the upper limit of change and cannot be further increased, but it is necessary to further increase the exposure, as in a case where the ISO sensitivity before the change is the ISO sensitivity normally set to the image capturing section 133, the exposure is similarly increased by controlling another exposure parameter, such as the aperture value. In a case where an ND filter is incorporated in the image capturing section 133, the exposure condition can be changed by changing the density of the ND filter instead of the aperture value.

The detailed description concerning the change of the exposure condition is as given above.

Referring again to FIG. 11, in the step S1108, the controller 111 determines whether or not to terminate video recording. Specifically, if the latest acquired maneuvering instruction information satisfies the shooting end condition in the shooting scenario acquired in the step S1101 (YES to S1108), the process proceeds to a step S1109, wherein the controller 111 terminates video recording performed by the image-capturable moving apparatus 100, followed by terminating the present process. On the other hand, if the latest acquired maneuvering instruction information does not satisfy the shooting end condition in the shooting scenario acquired in the step S1101 (NO to the step 1108), the process returns to the step S1103, and image-capturing and recording of the video is continued.

As described above, with the video recording process according to the present embodiment, the image-capturing conditions are changed according to the maneuvering instruction information, and hence it is possible to more quickly perform the exposure follow-up than in the conventional method in which the image-capturing conditions are changed according to image analysis information, and as a result, it is possible to acquire an excellent video having a high product quality.

Note that although in the present embodiment, the exposure condition is controlled only based on the maneuvering instruction information, the control of the exposure condition is not limited to this. For example, the exposure condition can be controlled based not only on the maneuvering instruction information, but also on a time or position information. Specifically, in a tunnel or at a time after sunset, the exposure condition is changed in response to a certain maneuvering instruction, but in a time zone in which it is bright in the daytime, even when the same maneuvering instruction is provided, the exposure condition is not changed or the like control is performed. Further, calculation of the exposure change amount can be performed not only based on the exposure change amount determined in advance in association with a predetermined maneuvering instruction, but also by taking the influence of surrounding environmental light into consideration.

Next, a fourth embodiment as the preferred embodiment of the present invention will be described below with reference to the drawings.

In the process (see FIG. 2) performed by the image-capturable moving apparatus 100 in the video recoding process according to the first embodiment, the maneuvering instruction information is received from the moving object 150 via the communication section 118. On the other hand, in the present embodiment, not only the maneuvering instruction information, but also environmental information is received from the moving object 150 via the communication section 118. The environmental information mentioned here refers to position information of the moving object 150, weather information in the vicinity of the moving object, a map, structure information, information including sunny area/shaded area information, and so forth. That is, the present embodiment is characterized in that the image-capturing condition controller 131 included in the image capturing device 130 controls the exposure condition of the image-capturing conditions at the time of image-capturing based on the received maneuvering instruction information and environmental information.

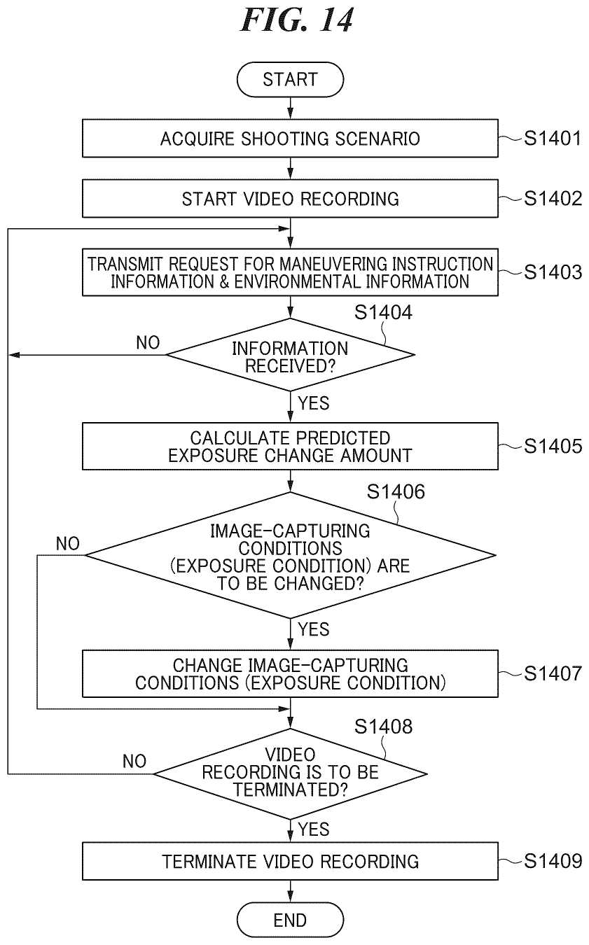

FIG. 14 is a flowchart of a process performed by the image-capturable moving apparatus 100 in the video recording process according to the present embodiment. The present process is executed by the controller 111 included in the mobile device 110, which loads a program stored in the ROM 112 into the RAM 113. Further, in the following description, when an executing entity other than the controller 111 executes a step, in actuality, the controller 111 controls the executing entity.

Steps S1401 and S1402 are the same as the steps S201 and S202 in FIG. 2 in the first embodiment, and hence description thereof is omitted.

In a step S1403, the controller 111 included in the mobile device 110 transmits a request for the maneuvering instruction information and the environmental information to the moving object 150 via the communication section 118.

Here, the maneuvering instruction information refers to instruction information concerning control of the steering wheel, the brake, and the accelerator of the moving object 150, for example. Although as mentioned above, the environmental information refers to the position information of the moving object 150, the weather information in the vicinity of the moving object 150, the map, the structure information, the information including the sunny area/shaded area information, and so forth.

In a step S1404, the controller 111 included in the mobile device 110 determines whether or not the maneuvering instruction information and the environmental information have been received from the moving object 150. If the maneuvering instruction information and the environmental information have been received (YES to S1404), the controller 111 transmits the received maneuvering instruction information and environmental information to the image-capturing condition controller 131 included in the image capturing device 130 and proceeds to a step S1405. On the other hand, if at least one of the maneuvering instruction information and the environmental information has not been received (NO to S1404), the process returns to the step S1403, and the controller 111 transmits the request for the maneuvering instruction information and the environmental information to the moving object 150 again.

In the step S1405, the image-capturing condition controller 131 included in the image capturing device 130 calculates a predicted exposure change amount based on the maneuvering instruction information and the environmental information, which are transmitted from the controller 111. The predicted exposure change amount is a value predicting what degree of change in exposure will occur after the lapse of what time period from the current time, e.g. due to switching between a sunny area and a shaded area. Details of the predicted exposure change amount will be described hereinafter.

In a step S1406, the image-capturing condition controller 131 included in the image capturing device 130 determines whether or not it is necessary to change the exposure condition of the image capturing device 130 based on the predicted exposure change amount calculated in the step S1405. If the predicted exposure change amount is equal to or larger than a threshold value, it is determined that it is necessary to change the image-capturing conditions (YES to S1406), so that the image-capturing condition controller 131 proceeds to a step S1407 to execute the exposure condition-changing processing for changing the image-capturing conditions (exposure condition), and then proceeds to a step S1408. On the other hand, if the predicted exposure change amount is smaller than the threshold value, it is determined that it is unnecessary to change the image-capturing conditions (NO to S1406), and the process proceeds to the step S1408.

Here, the exposure condition-changing processing executed in the step S1407 will be described with reference to drawings.

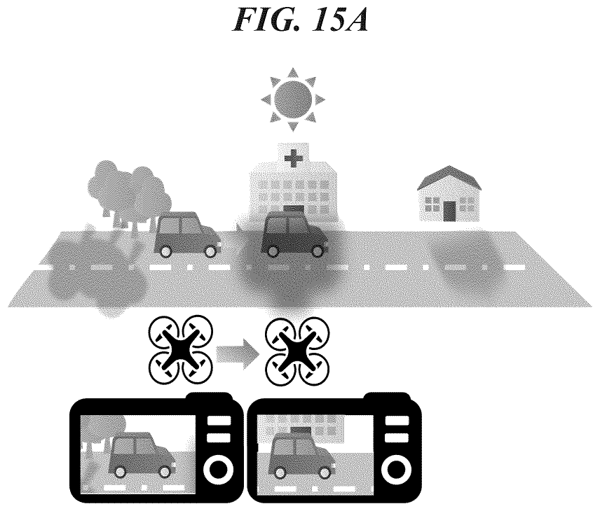

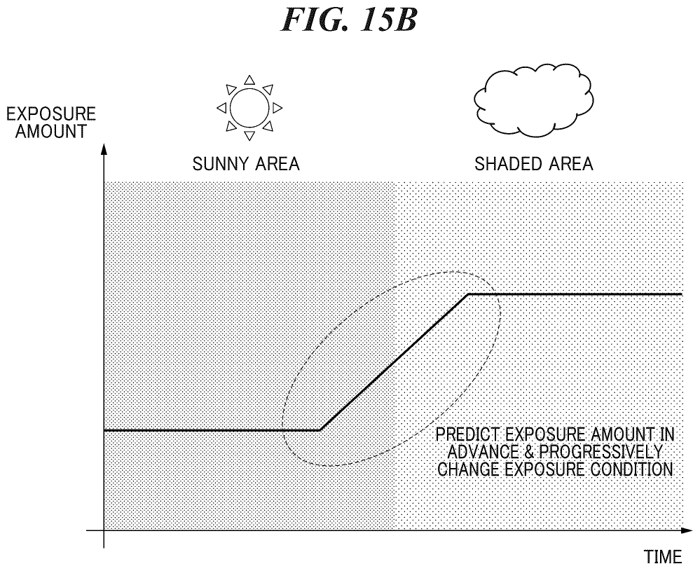

For example, as shown in FIG. 15A, let us consider a scene in which the moving object 150 is being shot by the image capturing device 130 under a condition that the sun is up in the daytime. Whenever the moving object 150 repeatedly and alternately passes a sunny area and a shaded area during image-capturing, the brightness of the moving object 150 and its vicinity changes. For this reason, to keep the video to be shot at a proper exposure or desired exposure, it is necessary to always change the exposure condition of the image capturing section 133.

Therefore, in the present embodiment, first, the position information, the peripheral structure information, the environmental information, such as the weather information, and the maneuvering instruction information concerning the brake, the accelerator, and so forth, from the moving object 150 are acquired. Next, the predicted exposure change amount is calculated from an exposure change amount at a time of switching between the sunny area and the shaded area, which is predicted based on the acquired environmental information and maneuvering instruction information, and time required to elapse until this change in exposure is caused. Then, if the calculated predicted exposure change amount is equal to or larger than the threshold value, the exposure condition-changing processing in the step S1407 is executed. Specifically, the image capturing section 133 progressively changes the exposure condition in advance as shown in FIG. 15B. This makes it possible to acquire a video which has a high product quality and in which a rapid change in exposure is not caused.

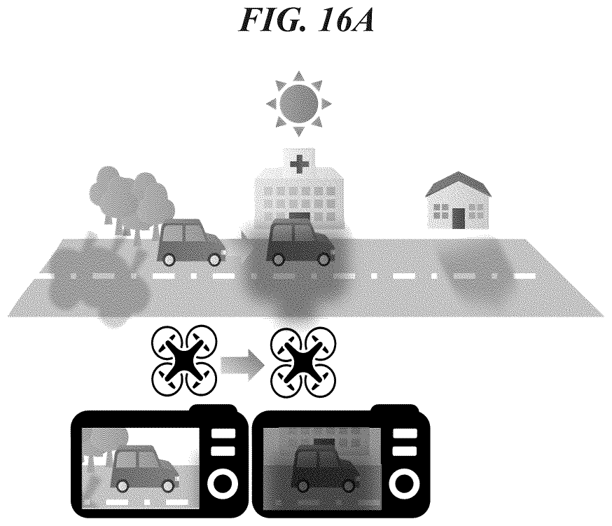

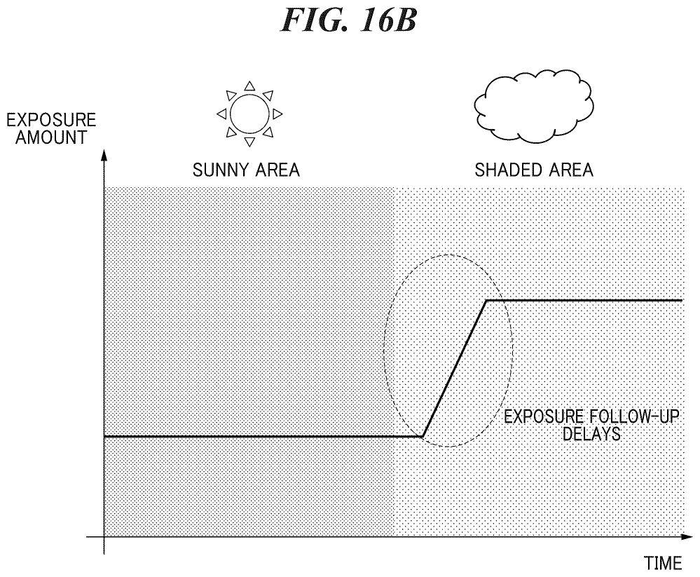

If the exposure condition of the image capturing section 133 is changed by using the method of analyzing the video and feeding back a result of the analysis in similar scenes, as shown in FIGS. 16A and 16B, it take some time to analyze the video, which causes a delay in the exposure follow-up of the image capturing section 133 with respect to the change in luminance of the moving object 150 and its vicinity. As a result, a lot of frames with improper exposure are generated, which degrades the quality of the video.

Further, control of timing of changing the exposure condition in the exposure condition-changing processing executed in the step S1407 will be described in detail with reference to another drawing.

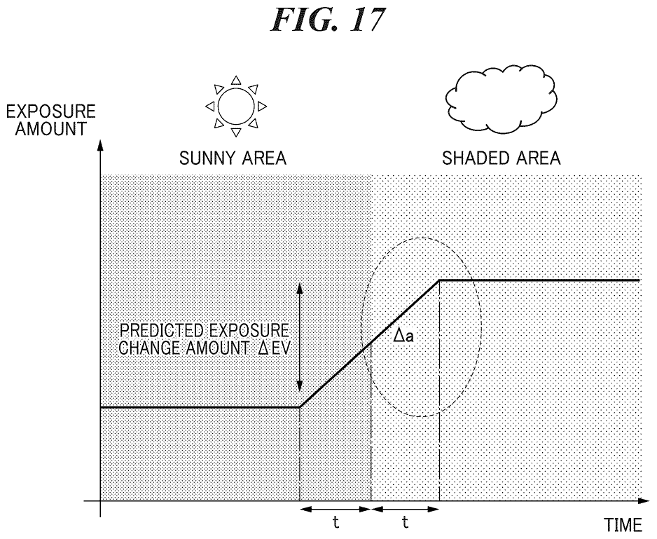

As shown in FIG. 17, for example, a difference between exposure amounts which produce a proper exposure condition for a sunny area and a shaded area, respectively, is set as a predicted exposure change amount. When the predicted exposure change amount is represented by ΔEV, an exposure change amount per one second (per unit time), with which the exposure of the shot video gently changes and the high quality can be preserved, is represented by Aa. Note that Δa can be set to a desired value by the user. The exposure condition change is started at t (sec) before a time at which the sunny area and the shaded area are switched, such that the exposure change amount per one second becomes equal to Δa. Here, t (sec) is calculated by the following equation (2):

$$t = Δ EV / 2 a \qquad ( 2 )$$

Note that in a case where a predicted period of switching between a sunny area and a shaded area is equal to or shorter than 2t (sec), the exposure condition is not changed. The predicted period of switching between a sunny area and a shaded area is calculated from actual distances of extensions of a sunny area and a shaded area and an estimated object speed.

The detailed description of the change of the exposure condition is given as described above.

Referring again to FIG. 14, in the step S1408, the controller 111 determines whether or not to terminate video recording. Specifically, if the latest received maneuvering instruction information satisfies the shooting end condition in the shooting scenario acquired in the step S1401 (YES to S1408), the process proceeds to a step S1409, wherein the controller 111 terminates video recording, which is performed by the image-capturable moving apparatus 100, followed by terminating the present process. On the other hand, if the latest received maneuvering instruction information does not satisfy the shooting end condition in the shooting scenario acquired in the step S1401 (NO to S1408), the process returns to the step1403, to continue video recording.

As described above, with the video recording process according to the present embodiment, the image-capturing conditions are changed according to the maneuvering instruction information and the environmental information, and hence it is possible to more quickly perform the exposure follow-up than in the conventional method in which the image-capturing conditions are changed according to image analysis information, and as a result, it is possible to acquire an excellent video having a high product quality.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-200676 filed Nov. 28, 2023, which is hereby incorporated by reference herein in its entirety.

What is claimed is:

1. An information processing system including a moving object involving maneuvering, and an image-capturable moving apparatus having an image capturing device mounted thereon which captures an image of the moving object, comprising:
at least one processor; and
a memory coupled to the at least one processor storing instructions that, when executed by the processor, cause the processor to function as:
an acquisition unit configured to acquire maneuvering instruction information of the moving object; and
an image capturing control unit configured to control image capturing performed by the image capturing device,
wherein the image capturing control unit controls image-capturing conditions at a time of image-capturing performed by the image capturing device, based on the maneuvering instruction information.

2. The information processing system according to claim 1, wherein the processor is caused to further function as a shooting scenario selection unit configured to select a shooting scenario from a shooting scenario list in which conditions concerning image-capturing are described, and
wherein the shooting scenario list describes a shooting start condition and a shooting end condition, which are determined based on at least the maneuvering instruction information, and the image-capturing conditions of the image capturing device.

3. The information processing system according to claim 1, wherein the image-capturing conditions include at least one of a frame rate, a shutter speed, and an exposure condition.

4. The information processing system according to claim 3, wherein the image capturing control unit controls the image capturing device to perform image capturing of the moving object involving maneuvering, according to the shooting start condition, the shooting end condition, and the image-capturing conditions, which are described in a shooting scenario selected by the shooting scenario selection unit.

5. The information processing system according to claim 1, wherein the maneuvering instruction information is information for instructing a position and an operation of the moving object.

6. The information processing system according to claim 5, wherein the maneuvering instruction information is information instructing at least one of a speed and an orientation of the movable object, an operation of a movable mechanism, a notification using sound or light, and light emission from a light source.

7. The information processing system according to claim 4, wherein the processor is caused to further function as a scene attention-getting degree determination unit configured to determine a scene attention-getting degree of an image-capturing scene based on the maneuvering instruction information.

8. The information processing system according to claim 7, wherein the image capturing control unit performs control to increase a frame rate in a case where it is determined that the scene attention-getting degree is high and performs control to reduce the frame rate in a case where it is determined that the scene attention-getting degree is low.

9. The information processing system according to claim 7, wherein in a case where the maneuvering instruction information concerns one of opening/closing of a window, blinking a direction indicator, and drift running, the scene attention-getting degree determination unit determines that the scene attention-getting degree is high.

10. The information processing system according to claim 8, wherein in a case where the maneuvering instruction information has not been provided for a predetermined time period, the scene attention-getting degree determination unit determines that the scene attention-getting degree is low.

11. The information processing system according to claim 8, wherein in a case where the maneuvering instruction information concerns reduction of the speed, the scene attention-getting degree determination unit determines that the scene attention-getting degree is low.

12. The information processing system according to claim 8, wherein the scene attention-getting degree determination unit acquires maneuvering instruction information of another moving object and determines the scene attention-getting degree by using the maneuvering instruction information of the other moving object in combination with the maneuvering instruction information.

13. The information processing system according to claim 8, wherein the scene attention-getting degree determination unit acquires image analysis information of the moving object and determines the scene attention-getting degree by using the image analysis information in combination with the maneuvering instruction information.

14. The information processing system according to claim 13, wherein the scene attention-getting degree determination unit acquires information on a landmark in the vicinity of the moving object and determines the scene attention-getting degree by using the image analysis information in combination with the information on the landmark.

15. The information processing system according to claim 8, wherein in a case where a condition for changing image-capturing conditions is not satisfied, the image capturing control unit does not change the frame rate based on the scene attention-getting degree.

16. The information processing system according to claim 8, wherein in a case where the frame rate has been changed based on the scene attention-getting degree, the image capturing device adds a flag for changing a reproduction speed when editing a video, and performs recording.

17. The information processing system according to claim 4, wherein the processor is caused to further function as a predicted panning amount calculation unit configured to calculate a predicted background-panning amount, based on the maneuvering instruction information.

18. The information processing system according to claim 17, wherein the processor is caused to further function as an ideal panning amount acquisition unit configured to acquire an ideal background-panning amount from the shooting scenario, and
wherein in a case where a difference between the predicted background-panning amount and the ideal background-panning amount is equal to or larger than a predetermined value, the image capturing control unit performs control to change at least the shutter speed.

19. The information processing system according to claim 17, wherein the predicted background-panning amount is calculated based on a predicted speed of the moving object based on at least the maneuvering instruction information, and the shutter speed.

20. The information processing system according to claim 18, wherein in a case where it is difficult to change the shutter speed based on the predicted background-panning amount and the ideal background-panning amount, the image capturing device adds a flag for causing a plurality of frames to be combined when editing a video.

21. The information processing system according to claim 18, wherein in a case where the condition for changing image-capturing conditions is not satisfied, the image capturing control unit does not change the shutter speed based on the predicted background-panning amount and the ideal background-panning amount.

22. The information processing system according to claim 4, wherein an exposure change amount associated with the maneuvering instruction information is acquired.

23. The information processing system according to claim 22, wherein in a case where the exposure change amount is equal to or larger than a threshold value, the image capturing control unit changes the exposure condition.

24. The information processing system according to claim 22, wherein the exposure condition is changed based on an ISO sensitivity.

25. The information processing system according to claim 24, wherein in a case where it is difficult to control exposure based on the ISO sensitivity, the exposure condition is changed based on at least one of an aperture value, a shutter speed, and a change in an ND filter.

26. The information processing system according to claim 1, wherein environmental information around the object involving maneuvering is acquired in addition to the maneuvering instruction information.

27. The information processing system according to claim 26, wherein the environmental information is information including at least one of position information of the object involving maneuvering, a weather around the object, a map, a structure, sunny/shaded areas, and a time.

28. The information processing system according to claim 27, wherein a predicted exposure change amount is calculated based on the maneuvering instruction information and the environmental information.

29. The information processing system according to claim 28, wherein the predicted exposure change amount is information including a predicted exposure change amount and a time required to elapse until a change in exposure occurs.

30. The information processing system according to claim 29, wherein the processor is caused to further function as a unit configured to input an exposure change amount per unit time, and
wherein the image capturing control unit calculates a time at which exposure control is to be started, based on the predicted exposure change amount and the exposure change amount per unit time, and controls the exposure based on the calculated time.

31. The information processing system according to claim 1, wherein in a case where it is difficult to acquire the maneuvering instruction information, the image capturing device controls the image-capturing conditions at the time of image-capturing based on at least image analysis information of the object involving maneuvering.

32. The information processing system according to claim 1, wherein the image capturing control unit is mounted on the image-capturable moving apparatus, and
wherein the acquisition unit acquires the maneuvering instruction information form the moving object by requesting the maneuvering instruction information to the moving object.

33. The information processing system according to claim 1, wherein the image capturing control unit is mounted on the moving object, and information for controlling the image-capturing conditions is transmitted from the moving object to the image-capturable moving apparatus.

34. The information processing system according to claim 2, wherein a main object is further described in the shooting scenario list.

35. An information processing apparatus that is communicably connected to a moving object involving maneuvering and an image-capturable moving apparatus having an image capturing device mounted thereon which captures an image of the moving object, comprising:
at least one processor; and
a memory coupled to the at least one processor storing instructions that, when executed by the processor, cause the processor to function as:
an acquisition unit configured to acquire maneuvering instruction information of the moving object from the moving object; and
an image capturing control unit configured to control image capturing performed by the image capturing device,
wherein the image capturing control unit transmits image-capturing conditions at a time of image-capturing to the image-capturable moving apparatus based on the maneuvering instruction information.

36. A method of controlling an information processing system including a moving object involving maneuvering and an image-capturable moving apparatus having an image capturing device mounted thereon which captures an image of the moving object, comprising:
acquiring maneuvering instruction information of the moving object; and
controlling image capturing performed by the image capturing device,
wherein the controlling includes controlling image-capturing conditions at a time of image-capturing, based on the maneuvering instruction information.

37. A method of controlling an information processing apparatus that is communicably connected to a moving object involving maneuvering and an image-capturable moving apparatus having an image capturing device mounted thereon which captures an image of the moving object, comprising:
acquiring maneuvering instruction information of the moving object from the moving object; and
controlling image capturing performed by the image capturing device,
wherein the controlling transmits image-capturing conditions at a time of image-capturing to the image-capturable moving apparatus based on the maneuvering instruction information.

38. A non-transitory computer-readable storage medium storing a program for causing a computer to execute a method of controlling an information processing system including a moving object involving maneuvering and an image-capturable moving apparatus having an image capturing device mounted thereon which captures an image of the moving object,
wherein the method comprises:
acquiring maneuvering instruction information of the moving object; and
controlling image capturing performed by the image capturing device,
wherein the controlling includes controlling image-capturing conditions at a time of image-capturing, based on the maneuvering instruction information.

39. A non-transitory computer-readable storage medium storing a program for causing a computer to execute a method of controlling an information processing apparatus that is communicably connected to a moving object involving maneuvering and an image-capturable moving apparatus having an image capturing device mounted thereon which captures an image of the moving object,
wherein the method comprises:
acquiring maneuvering instruction information of the moving object from the moving object; and
controlling image capturing performed by the image capturing device,
wherein the controlling transmits image-capturing conditions at a time of image-capturing to the image-capturable moving apparatus based on the maneuvering instruction information.
